(19) United States
(12) Patent Application Publication
(10) Pub. No.: US 2009/0313243 A1
(43) Pub. Date: Dec. 17, 2009

(54) METHOD AND APPARATUS FOR PROCESSING SEMANTIC DATA RESOURCES

(75) Inventors: Paul Buitelaar, Saarbruecken (DE); Pinar Wennerberg, Munich (DE); Sonja Zillner, Munich (DE)

Correspondence Address: STAAS & HALSEY LLP, SUITE 700, 1201 NEW YORK AVENUE, N.W., WASHINGTON, DC, 20005, US

(73) Assignee: SIEMENS AKTIENGESELLSCHAFT, Munich (DE)

(21) Appl. No.: 12/324,619

(22) Filed: Nov. 26, 2008

(30) Foreign Application Priority Data
Jun. 13, 2008 (EP) 08010815

(51) Int. Cl. G06F 7/06; G06F 17/30

(52) U.S. Cl. 707/5; 707/E17.014; 707/E17.108

(57) ABSTRACT

A semantic data resource of a domain is processed by calculating relevance scores for terms which occur in domain corpora and weighting the semantic data resource depending on the relevance scores calculated for these terms. The semantic data resource may include domain-specific terms and relations, such as a domain ontology, a domain terminology and a domain classification. The domain ontology may include a domain-specific-hierarchy of terms assigned to nodes which are connected by edges and may be encoded in a web ontology language. The relevance scores may be chi-square scores which are calculated depending on a frequency of a term in the domain corpora and an expected frequency of the term.

### CROSS REFERENCE TO RELATED APPLICATIONS

This application is based on and hereby claims priority to European Patent Application No. 08010815 filed on Jun. 13, 2008, the contents of which are hereby incorporated by reference.

### BACKGROUND

Described below are a method and an apparatus for processing semantic data resources of a domain and in particular data resources such as ontology, terminology and classifications in the medical domain.

Through the advanced technologies in the clinical care and research, especially the rapid progress in imaging technologies more and more medical imaging data and patient text data is generated by hospitals, pharmaceutical companies and medical research institutes. Because of the plurality of available data which is provided by a number of different data sources it is difficult to identify potential queries reflecting different perspectives that can be used by clinicians and radiologists to find patient-specific sets of relevant images.

### SUMMARY

Described below is a method for processing at least one semantic data resource of a domain, including calculating relevance scores for terms which occur in domain corpora and weighting the semantic data resources depending on the calculated relevance scores of the terms.

In an embodiment the semantic data resource includes domain-specific terms and relations.

In an embodiment the semantic data resources include a domain ontology, a domain terminology and a domain classification.

In an embodiment the domain ontology includes a domain-specific-hierarchy of terms assigned to nodes which are connected by edges.

In an embodiment the domain terminology includes a lexicon having domain-specific terms, relations and synonyms.

In an embodiment the domain classification includes codes classifying domain-specific terms.

In an embodiment the relevance scores are chi-square-scores which are calculated depending on a frequency of a term in the domain corpora and an expected frequency of the term.

In an embodiment the expected frequency of the term is derived from a reference corpus.

In an embodiment the domain corpora are formed by text corpora.

In an embodiment the domain ontology is encoded in a web ontology language (OWL).

In an embodiment the domain corpora include an XML-(extended mark-up language) format.

In an embodiment the reference corpus is formed by the British National corpus.

In an embodiment for the domain corpora a list of relevant terms is generated.

In an embodiment the list of terms is filtered according to a predetermined filter criterion.

In an embodiment each term includes one or more words.

In an embodiment a relevance score for a multi-word term is calculated on the basis of the chi-square-score for each noun or adjective in the multi-word term which are summed and normalized over the length of the multi-word term.

In an embodiment each term is marked by a part of speech information.

Described below is an apparatus for processing a semantic data resource of a domain that includes a memory storing the semantic data resource and a calculation unit calculating relevance scores for terms which occur in domain corpora and weighting the semantic data resource depending on the calculated relevance scores of the terms.

In an embodiment the apparatus includes a network interface for receiving the domain corpora from a network.

In an embodiment the network interface is provided for receiving domain corpora from the world wide web.

In an embodiment the apparatus includes a user interface for outputting the weighted semantic data resources.

In an embodiment the calculation unit includes a microprocessor for executing a computer program for calculating relevance scores for terms and weighting the semantic data resources depending on the calculated relevance scores.

Also described below is a computer-readable storage medium encoded with a computer program having commands for executing a method for processing a semantic data resource of a domain including calculating relevance scores for terms which occur in domain corpora and weighting the semantic data resource depending on the calculated relevance scores of the terms.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is a block diagram of a possible embodiment of an apparatus for processing semantic data resources of a domain;

FIG. 2 is flowchart illustrating a method for processing semantic data resources of a domain;

FIG. 3 provides three tables of relevant terms of a domain ontology for different corpora in the medical domain;

FIG. 4 provides three tables of relevant terms of a domain terminology for different corpora in the medical domain;

FIG. 5 provides three tables of relevant terms of a subset terminology according to a domain classification in a domain terminology of a lexicon which occur in corpora of the medical domain;

FIG. 6 provides three tables of relevant terms which occur in common domain corpora of the medical domain on the basis of different semantic data resources.

### DETAILED DESCRIPTION

Reference will now be made in detail to the exemplary embodiments, examples of which are illustrated in the accompanying drawings, wherein like reference numerals refer to like elements throughout.

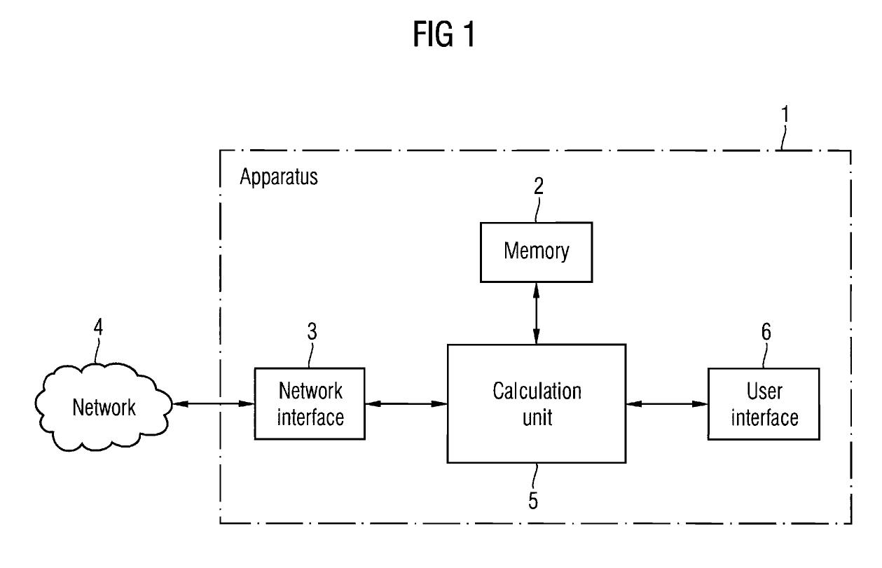

As can be seen from FIG. 1 an apparatus 1 for processing semantic data resources of a domain includes in the shown embodiment a memory 2 for storing at least one semantic data resource in a data base. In an alternative embodiment the semantic data resource is loaded into the apparatus 1 from a distant data base connected to the apparatus 1 via a network. The semantic data resource contains semantic knowledge or semantic information data which is domain-specific such as the domain ontology or the domain terminology or a domain classification. The semantic data resource stored in the memory 2 includes domain-specific terms and relations. The semantic data resource can be formed by a domain ontology which includes a domain-specific-hierarchy of terms assigned to nodes which are connected by edges. This domain ontology can be encoded by a web ontology language (OWL).

An ontology is a formal representation of a set of concepts within a domain and the relationships between those concepts. Common components of ontology include individuals such as instances or objects, classes, attributes, relations, function terms, restrictions, rules, actions and events. Individuals or instances are the basic ground level components of the domain ontology. Individuals in the domain ontology may include complete objects of the domain as well as abstract individuals such as numbers and words. Classes also called type, sort, category and kind are abstract groups, sets or collections of objects. Classes may contain individuals other classes or a combination of both. A class of a domain ontology can include other classes which are also called subclasses. Objects in the ontology can be described by assigning attributes to them. Each attribute within the domain ontology has at least a name and a value and can be used to store information data that is specific to the object to which the attribute is attached. With the use of attributes it is possible to describe relationships between objects in the ontology. In the ontology a hierarchical taxonomy can be provided which indicates how objects relate to one and other.

The ontology forms a semantic data resource in a specific domain such as the medical domain. In a possible embodiment the main ontology is generated by merging other domain ontologies into a more general representation. Different ontologies in the same domain can arise due to different perceptions of the domain based on the background, education or representation languages. The main ontology can be encoded by a formal language such as OWL, RDF or RDFS. Other ontology languages can be used as well.

In a possible embodiment the domain specific ontology is from the medical domain. For example the foundation and module of anatomy—(FMA) ontology can be used as a knowledge-base data resource of the medical domain. The FMA-ontology specifies an anatomy taxonomy and corresponding relationships. The FMA-ontology covers a plurality of anatomical concepts and a huge number of relations instances from any relation types. The complex terminological structure of the FMA-ontology provides a linguistically attractive semantic data resource. For example a common structure of the FMA-terminology is the following:
modifier [ANATOMICAL STRUCTURE]
   where the modifier is one of the following:
modifier={left, right, upper,
. . . }
   as in
left neck of mandible,
right neck of mandible,
upper trunk
   wherein all modifiers indicate an anatomical location so that the FMA-ontology can be processed to generate domain relevant information data such as spatial relationships.

Moreover, the terms in the FMA-ontology can formed cascaded structures in the one term occurs with in another term such as in:
Abdominal aorta
Abdominal aortic plexus
Abdominal aortic nerve plexus

The FMA-ontology is a machine readable anatomy data resource in the medical domain.

Further, the data resource process performed by the method can be formed by a domain terminology. This domain terminology can include a lexicon including a plurality of domain specific terms, relations and synonyms. An example for a domain terminology in the medical domain is the radiology lexicon which is a data resource for obtaining image relevant information. The radiology lexicon is an open source control vocabulary for the purpose of uniform indexing and retrieval of radiology information data. The radiological lexicon includes several thousand anatomic and pathological terms including terms about imaging techniques, difficulties and diagnostic image qualities. The radiology lexicon is a unified lexicon to capture cross vocabulary radiology information and it contains besides domain specific knowledge also lexical relationships such as synonyms.

A further type of semantic data resources are domain classifications. In a domain classification the domain classification includes for example codes classifying domain-specific terms. In an embodiment a domain classification as a data resource is formed by the international classification of diseases ICD. The international classification of diseases (ICD) is a collection of codes classifying diseases, signs, symptoms, abnormal findings etc. provided by a database of the world health organisation. The international classification of diseases (ICD) classifies diseases under digit codes which can include several digits. For example the international classification of diseases ICD classifies lymph nodes of head, face and neck under neoplasms (140-249) meaning that any disease that is coded with a number between 140 and 249 is a neoplasm. The lymph nodes of head, face and neck has the code 196.0 and forms a subcategory of secondary and unspecified, malignant neoplasm of lymph nodes that has the code 196.

In the embodiment shown in FIG. 1 several semantic data resources such as domain ontologies, domain terminologies and domain classifications can be stored in the memory 2 or downloaded from another database via a network.

The apparatus 1 shown in the embodiment of FIG. 1 includes a network interface 3 connecting the apparatus 1 to a network 4 such as the world wide web. In a possible embodiment of the apparatus 1 and the method, domain corpora are downloaded from several databases of the network 4. In a possible embodiment these corpora of the relevant domain, e.g. corpora of the medical domain, corpora can include text corpora. For example, the downloaded text corpora can be based on categories of the medical domain such as anatomy, radiology and disease. In a possible embodiment for each category of the domain a plurality of web pages can be downloaded by the apparatus 1 from the network 4 and filtered according to different criteria. In a possible embodiment the filter criteria are set by a user or set according to a configuration of the apparatus 1. A possible embodiment a XML-version of the downloaded documents is generated and applied to a calculation unit 5 of the apparatus 1. The calculation unit 5 calculates relevance scores for terms which occur in the domain corpora and weights the semantic data resources stored in the memory 2 depending on the calculated relevance scores of these terms.

In a possible embodiment the calculation unit 5 of the apparatus 1 includes a microprocessor for executing a computer program. This computer program can be stored in a program memory. In a possible embodiment the computer program is read from a data carrier storing the computer program.

The calculation unit 5 is further connected to a user interface 6 of the apparatus 1 such as a display for outputting the weighted semantic data resources. In a possible embodiment the user interface 6 is formed by a display for displaying tables indicating list of terms which are weighted according to the calculated relevance scores for the terms.

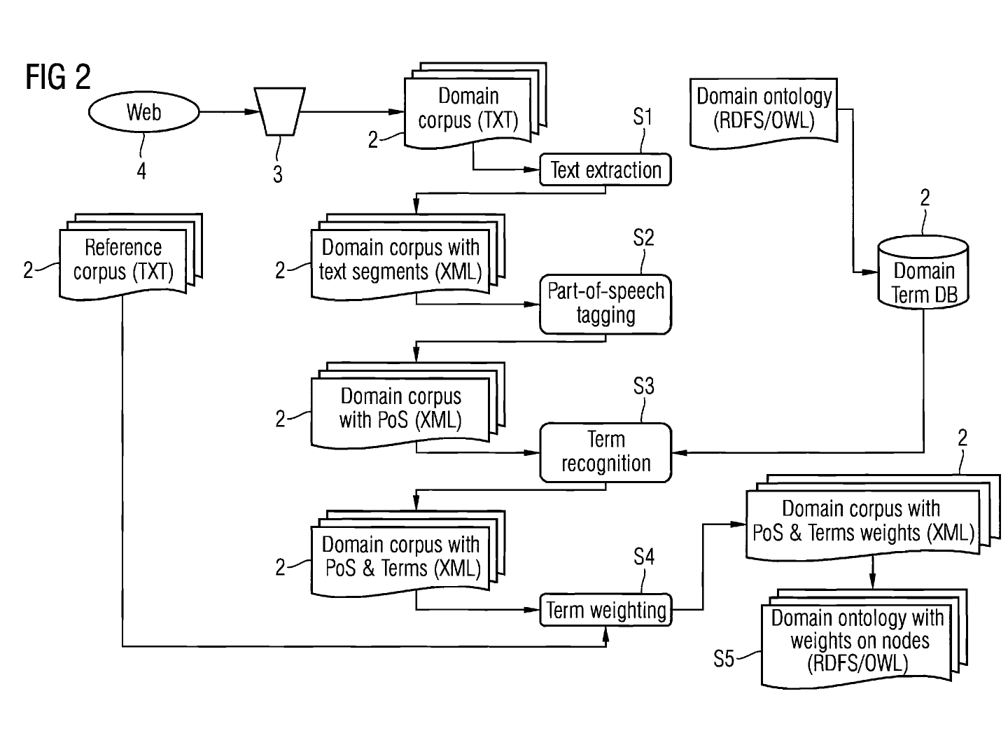

FIG. 2 is a flowchart illustrating a method for processing the data resources of a domain.

As can be seen from FIG. 2 the domain corpora such as web pages from the world wide web 4 are downloaded via the network interface 3 of the apparatus 1 and stored as domain corpora in its memory 2.

In FIG. 2 a possible embodiment a text extraction is performed at S1. The domain corpora stored in the memory 2 which can be downloaded from the Internet include a plurality of web pages that are relevant in the medical domain such as text corpora of the human anatomy. These web pages can be filtered according to a selection criterion. For example, all web pages or text corpora concerned with animal anatomy are removed. On the basis of the URLs of the filtered web pages a XML-version of the text corpora is generated or downloaded from the network 4. In the same manner other corpora from different categories such as disease and radiology corpora in the medical domain can be downloaded and the text can be extracted at S1.

The domain corpora with the text segments in XML-format are written back in the memory 2 of the apparatus 1 and a part of speech (POS) tagging is performed at S2. In a possible embodiment text sections of each domain corpus stored in the memory 2 are run through an TNT-part-of-speech-parser to extract all nouns in the domain corpus. In a possible embodiment each term of the domain corpus is marked with a part-of-speech (POS) information data which indicate for example whether the respective term is an adjective, a noun or a plural-noun. The tagged domain corpus is written back in the memory 2 as shown in FIG. 2.

At S3 a term recognition is performed. This is done on the basis of a domain term data base which is provided in a possible embodiment also in the memory 2 of the apparatus 1. The domain term database stores at least one semantic data resource of the domain such as the medical domain. These semantic data resources include domain ontologies, domain terminologies and domain classifications wherein the domain ontologies can be encoded by the web ontology languages OWL or RDFS. At S3 it is identified which terms from which data resource occur in the corresponding context corpus, i.e. in the different domain corpora such as the anatomy corpus, the radiology corpus and the disease corpus.

Each identified term is written back into the memory 2 along with the part of speech tags and relevant scores for those terms which occur in the domain corpora are calculated by the calculation unit 5 at S4. Then the semantic data resources are weighted by the calculation unit 5 depending on the calculated relevance scores of the identified terms. In a possible embodiment the relevance scores are chi-square scores which are calculated depending on a frequency of a term in a domain corpus and depending on an expected frequency of this term. The expected frequency of the term is derived in a possible embodiment from a reference corpus. This reference corpus can be formed for example by the British National Corpus BNC and it is a collection of samples of written and spoken language documents from a wide range of sources designed to represent a wide-cross-section of British English. This reference corpus is stored in a possible embodiment also in the memory 2 of the apparatus 1. In an alternative embodiment the reference corpus is downloaded via the network interface 3 from the world wide web 4.

In a possible embodiment chi-square scores are calculated according to the following equation:

$${χ}^{2} = {\sum }_{i = 1}^{n} \frac{{( {O}_{i} - {E}_{i} )}^{2}}{{E}_{i}}$$

where

Oᵢ=an observed frequency;

Eᵢ=an expected frequency,

n=the number of possible outcomes of each event.

Each term weighted at S4 can include one or more words. The relevance score for a multi-word term is calculated on the basis of the chi-square score for each noun or adjective in the multi-word term which are summed and normalized over the length of the multi-word term. Weighted terms are written back to the memory 2. Further, at S5 the weighted semantic data resources such as weighted domain ontologies are output by the apparatus 1 via the user interface 6.

In a possible embodiment an FMA-ontology is used to identify the human anatomy relevant terms and relationships from different text corpora. First, the concept and relationships are extracted yielding in a specific example a list of several thousand (e.g. 124769) entries. This list can include very dynamic terms such as “anatomical structure” as well as very specific terms such as “Anastomotic branch of right inferior cerebella artery with right superior cerebella artery”. This very generic terms and very specific terms are filtered out according to a filter criterion. For example from the list of terms only those concentrating on terms consisting up to three-words are not filtered out. In the specific example after filtering such terms the resulting list of terms consists of a lower number of terms such as 19337 terms including terms such as “up-dominal lymph node”, “femoral head”, “jugular lymphatic trunk” etc. The statistically most relevant terms of this ontology are identified on the basis of the chi-square scores computed for nouns of each text corpus. Single word terms in the FMA-ontology and occurring in the text corpus of the domain correspond directly to the noun that the term is built up of (e.g. the noun “ear” corresponding to the FMA-term “ear”). In this case the statistic relevance of the term is the chi-square score of the corresponding noun.

In the case of multi-word terms occurring in the corpus the statistic relevance is computed on the basis of the chi-square score for each constituting noun and/or adjective in the term which are summed and normalized over the length of the term. For example the relevance value or relevance score for “lymph node” is the summation of the chi-square scores for “lymph” and/or “node” divided by two. In order to take frequency into account the summed relevance score is multiplied by the frequency of the term. This assures that only frequently occurring terms are judged to be relevant. The FMA-ontology is very complex from a terminology prospective and therefore rich in lexical information. In order to capture this lexical information each term is additionally marked with a part of speech information. The same approach can be adapted for other terminologies.

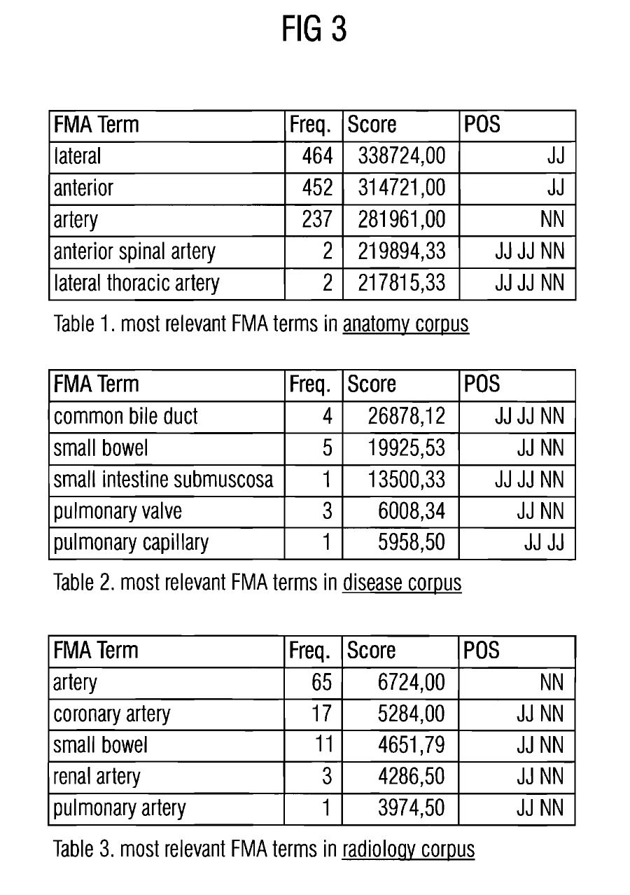

A selection of a resulting list of most relevant FMA-terms in different medical domain corpus are shown in the tables of FIG. 3. In the part of speech tags JJ stands for adjective, NN for noun and NNS for plural noun.

As can be seen from FIG. 3 the term “artery” either by itself or as a part of other terms as in “anterior spinal artery” occurs quite frequently both in the anatomy and in the radiology corpus. This confirms the role of arteries as a spatial coordination system. When studying image scans radiologists can determine the current position in the human body based on the specific artery found on the image. As a result the term “artery” and its subterms are highly relevant for the anatomy and spatial radiology domains and less for the disease domain as is also reflected by the different text corpora.

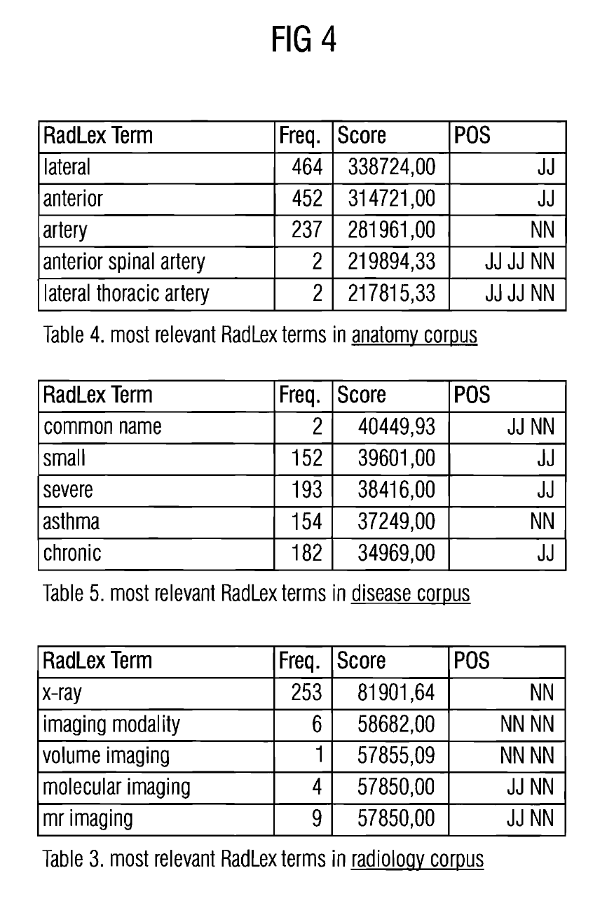

In the same manner terms of the radiology lexicon can be used to identify most relevant radiology terms in different corpora of the medical domain. In a specific example a list of terms that consists of 13156 entries is extracted from the RadLex data resource controlled vocabulary by parsing the downloaded version from the websites. After filtering duplicates are removed is the list can be reduced to, e.g., 12055 entries. In contrast to the FMA-ontology also very specific terms e.g. terms including more than three words, can be kept in the resulting term list because there are only view terms including more than three words. The most relevant RadLex terms in the given example are shown in FIG. 4. As can be seen the most relevant RadLex terms in the anatomy corpus accumulate around the term “artery” whereas they are more disease oriented in the disease corpus.

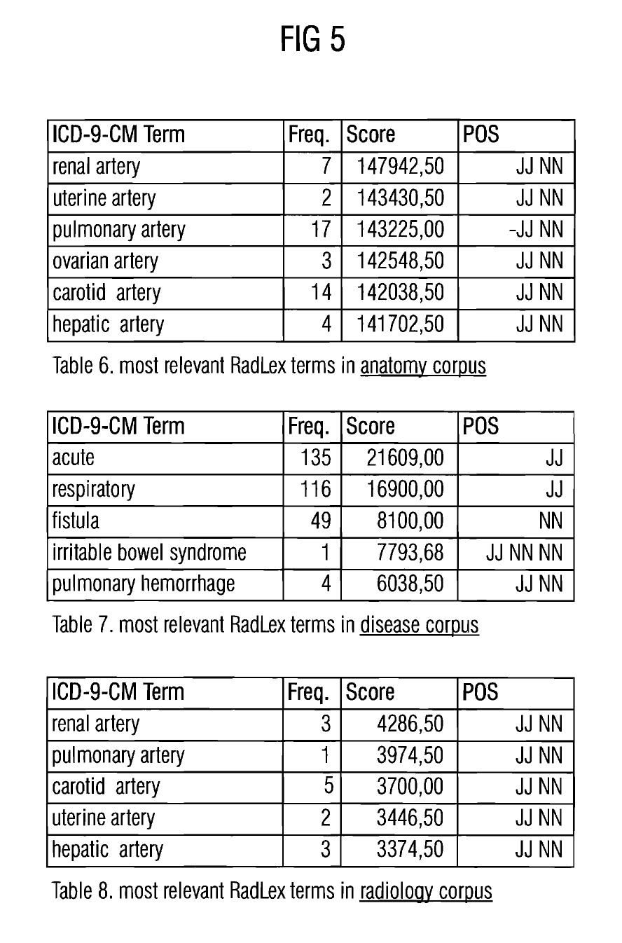

In a similar way an ICD-subset terminology that corresponds to RadLex terms can be analysed in the corpora. In a specific example a subset term list can consist of 3193 entries where for each entry its ICD-9 CM code and the corresponding RadLex ID are encoded. After searching for these terms in three text corpora of the medical domain the results as shown in the tables of FIG. 5 can be obtained.

Comparing the tables in FIG. 5 it can be observed that the most relevant terms in the anatomy corpus and in the radiology corpus concentrate on the term “artery”. This can be explained by the fact that artery provide important information for the spatial orientation in images.

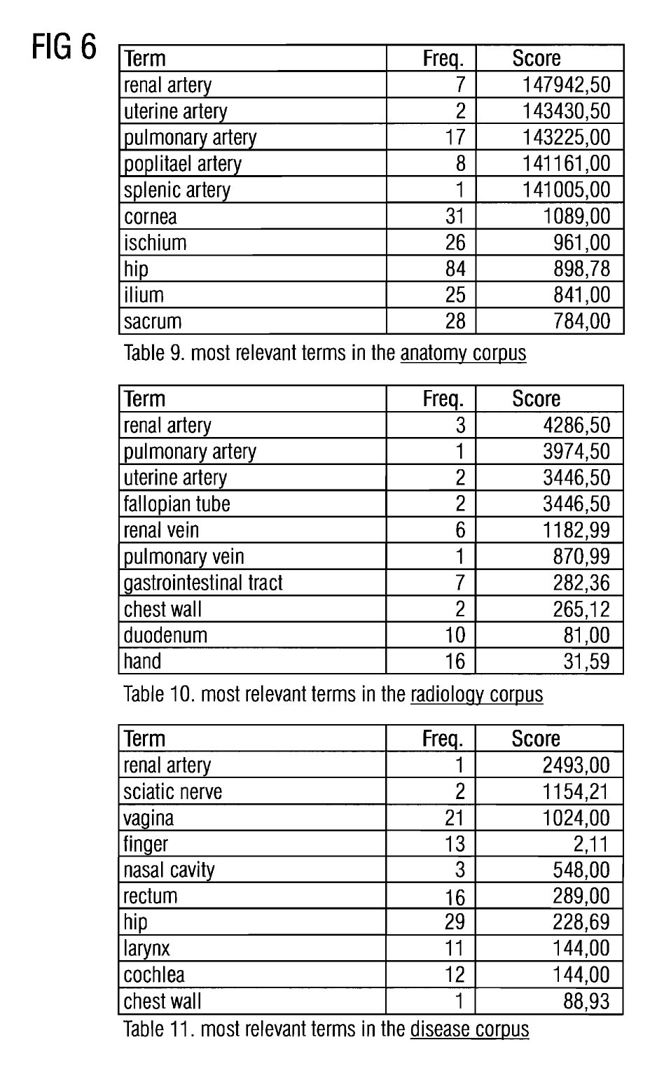

In order to obtain a joint view as reflection of different semantic knowledge data resources and terminologies covering different prospects on the basis of joint data sets in a possible embodiment the terminologies for the FMA-ontology the RadLex lexicon and the ICD-9 CM classification of disease codes are used as the data basis. A common view is presented in the tables of FIG. 6. Each table indicates the terms that are common for all three vocabularies and the statistical profile respective of the context corpus.

In the given example an ontology of human anatomy, a controlled vocabulary for radiology and the international classification of disease codes are used as knowledge resources in driving significant concepts and relations. These concepts and relations extracted by the method described herein can be used to generate potential query patterns. These query patterns form the basis for actual queries that clinicians pose on a semantic search engine to find patient-specific sets of relevant images and textual data.

The system also includes permanent or removable storage, such as magnetic and optical discs, RAM, ROM, etc. on which the process and data structures of the present invention can be stored and distributed. The processes can also be distributed via, for example, downloading over a network such as the Internet. The system can output the results to a display device, printer, readily accessible memory or another computer on a network.

A description has been provided with particular reference to exemplary embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1. A method for processing a semantic data resource of a domain, comprising:
calculating relevance scores for terms which occur in domain corpora; and
weighting the semantic data resource depending on the relevance scores calculated for the terms.

2. The method according to claim 1, wherein the semantic data resource includes domain-specific terms and relations.

3. The method according to claim 1, wherein the semantic data resource includes a domain ontology, a domain terminology and a domain classification.

4. The method according to claim 3, wherein the domain ontology includes a domain-specific-hierarchy of terms assigned to nodes which are connected by edges.

5. The method according to claim 3, wherein the domain terminology includes a lexicon having domain-specific terms, relations and synonyms.

6. The method according to claim 3, wherein the domain classification includes codes classifying domain-specific terms.

7. The method according to claim 3, wherein the domain ontology is encoded in a web ontology language.

8. The method according to claim 1, wherein the relevance scores include chi-square scores which are calculated depending on a frequency of a term in the domain corpora and an expected frequency of the term.

9. The method according to claim 8, wherein the expected frequency of the term is derived from a reference corpus.

10. The method according to claim 9, wherein the reference corpus is formed by the British National corpus.

11. The method according to claim 1, wherein the domain corpora are formed by text corpora.

12. The method according to claim 1, wherein the domain corpora include an XML-format.

13. The method according to claim 1, further comprising generating a list of relevant terms for the domain corpora.

14. The method according to claim 13, further comprising filtering the list of relevant terms according to a predetermined filter criterion.

15. The method according to claim 1, wherein each term includes one or more words.

16. The method according to claim 15, wherein said calculating includes calculating a relevance score for a multi-word term based on a chi-square score for each noun or adjective in the multi-word term which are summed and normalized over the length of the multi-word term.

17. The method according to claim 1, wherein each term is marked by part-of-speech information.

18. An apparatus for processing a semantic data resource of a domain, comprising:
a memory storing the semantic data resource; and
a calculation unit, coupled to said memory, calculating relevance scores for terms which occur in domain corpora and weighting the semantic data resource depending on the relevance scores calculated for the terms to produce weighted semantic data resources.

19. The apparatus according to claim 18, wherein the apparatus is connected to a network, and
wherein the apparatus further comprises an network interface for receiving the domain corpora from the network.

20. The apparatus according to claim 19, wherein the network is the world wide web.

21. The apparatus according to claim 18, further comprising a user interface, coupled to at least one of said calculation unit and said memory, for outputting the weighted semantic data resources.

22. The apparatus according to claim 18, wherein said calculation unit comprises a microprocessor executing a program calculating relevance scores for terms and weighting the semantic data resources depending on the calculated relevance scores.

23. An apparatus for processing at least one semantic data resource of a domain, comprising:
means for storing the semantic data resources; and
means for calculating relevance scores for terms which occur in domain corpora and for weighting the semantic resources depending on the relevance scores calculated for the terms.

24. A computer-readable medium encoded with instructions that when executed by a processor causes the processor to perform a method comprising:
calculating relevance scores for terms which occur in domain corpora; and
weighting the semantic data resource depending on the relevance scores calculated for the terms.

25. The computer-readable medium according to claim 24, wherein the semantic data resource includes domain-specific terms and relations.

26. The computer-readable medium according to claim 24, wherein the semantic data resource includes a domain ontology, a domain terminology and a domain classification.

27. The computer-readable medium according to claim 26, wherein the domain ontology includes a domain-specific-hierarchy of terms assigned to nodes which are connected by edges.

28. The computer-readable medium according to claim 26, wherein the domain terminology includes a lexicon having domain-specific terms, relations and synonyms.

29. The computer-readable medium according to claim 26, wherein the domain classification includes codes classifying domain-specific terms.

30. The computer-readable medium according to claim 26, wherein the domain ontology is encoded in a web ontology language.

31. The computer-readable medium according to claim 24, wherein the relevance scores include chi-square scores which are calculated depending on a frequency of a term in the domain corpora and an expected frequency of the term.

32. The computer-readable medium according to claim 31, wherein the expected frequency of the term is derived from a reference corpus.

33. The computer-readable medium according to claim 32, wherein the reference corpus is formed by the British National corpus.

34. The computer-readable medium according to claim 24, wherein the domain corpora are formed by text corpora.

35. The computer-readable medium according to claim 24, wherein the domain corpora include an XML-format.

36. The computer-readable medium according to claim 24, wherein said method further comprises generating a list of relevant terms for the domain corpora.

37. The computer-readable medium according to claim 36, wherein said method further comprises filtering the list of relevant terms according to a predetermined filter criterion.

38. The computer-readable medium according to claim 24, wherein each term includes one or more words.

39. The computer-readable medium according to claim 38, wherein said calculating includes calculating a relevance score for a multi-word term based on a chi-square score for each noun or adjective in the multi-word term which are summed and normalized over the length of the multi-word term.

40. The computer-readable medium according to claim 24, wherein each term is marked by part-of-speech information.
